(19) United States
(12) Patent Application Publication
(10) Pub. No.: US 2004/0181696 A1
(43) Pub. Date: Sep. 16, 2004

(54) Temporary password login

(76) Inventor: William T. Walker, Evergreen, CO (US)

Correspondence Address: Douglas W. Swartz, SHERIDAN ROSS P.C., Suite 1200, 1560 Broadway, Denver, CO, 80202-5141, US

(21) Appl. No.: 10/387,182

(22) Filed: Mar. 11, 2003

(51) Int. Cl. H04L 9/00

(52) U.S. Cl. 713/202

(57) ABSTRACT

A telecommunications component, such as a switch or server, is provided that includes a timer 120 and an access agent 116 operable to (a) authenticate a user using a first (typically dynamic) password; (b) after the user is successfully authenticated using the first password, receive a request from the user for a second (temporary, typically non-dynamic) password to be authorized for at least one of the user and a login associated with the user; (c) provide the user with the second password; and {d} initiate the timer to determine when an assigned life for the second password has expired.

### FIELD OF THE INVENTION

The present invention is directed specifically to authentication systems and specifically to authentication systems for telecommunication systems.

### BACKGROUND OF THE INVENTION

After software is installed in a system (particularly a telecommunication system), it is often necessary to establish temporary or permanent service logins within the system for maintenance or service personnel. These service logins must be very secure to prevent the existence of the login not only from presenting a security risk for the customer but also from being compromised by the customer who can then change the software and right-to-use restrictions for the software. As used herein, a “login” refers to a sequence of symbols and/or characters or a combination of symbol and/or character sequences, such as a user ID or login name and a password and/or a key, that must be correctly inputted into a computational component for a user to be authorized to perform one or more functions using or otherwise involving the computational component. As will be appreciated, a “password” is a unique character and/or symbol or sequence of characters and/or symbols known to a computational component and to a user who must specify the character and/or symbol or character and/or symbol sequence to be authorized to perform one or more functions using or otherwise involving the computational component. The symbol(s) or character(s) can be alphabetical, numerical, alphanumerical, and the like.

To provide strong security, logins can be protected by dynamic passwords instead of by static passwords. In dynamic passwords, to gain access to a protected login the user must enter a response (the dynamic password) to a challenge presented by the computational system. The correct response to the challenge (or dynamic password) is calculated or derived from a secret key and the challenge. A “key” is a sequence of symbols and/or characters used with a cryptographic algorithm for encrypting or decrypting data. Examples of keys include key-encrypting keys, key-exchange keys, master keys, private keys, and public keys. Since the response and not the secret key is entered, it is not possible to gain knowledge of the secret key by monitoring the login session. Also because the challenge is dynamic (temporally changing), the response (or dynamic password) is also dynamic and re-using a previous response in an attempt to gain access to the computational component will not work. By contrast in static passwords to gain access to a protected login the user must simply enter the password itself correctly without prior receipt of a challenge or input of a response to a challenge or knowledge of the key.

To obtain the appropriate dynamic password response for system access, service personnel can use various communication techniques, such as wireless or wired telephone or Internet access, to contact a challenge/response computer system. All of these methods are time consuming relative to a simple password login (e.g., 5 minutes versus less than 1 minute) and require access to a network or phone connection. These problems are compounded where service personnel must use the dynamic login multiple times (e.g., for new system installation or maintenance activities that entail multiple system resets).

### SUMMARY OF THE INVENTION

These and other needs are addressed by the various embodiments and configurations of the present invention. The present invention provides a device and method for providing a temporary password to users who are first successfully authenticated by another technique.

In one embodiment of the present invention, a method for providing access to a computational component is provided that includes the steps of:

(a) authenticating a user using a first password;

(b) after the user is successfully authenticated using the first password, receiving a request from the user for a second password to be authorized for the user and/or a login associated with the user;

(c) providing the user with the second (temporary) password; and

(d) initiating a timer to determine when an assigned life for the second password has expired. The second password is a temporary password which maybe used by a user to gain access to a computational component and which, when the assigned life for the second password has expired, is deactivated.

In one configuration, the first password is a dynamic password and the second password is a static password. In this configuration, the dynamic password maintains a high level of system security by conditioning the assignment of a temporary password on prior successful authentication using the dynamic password. Compared to dynamic passwords alone, the temporary password, once generated and so long as it is active, can provide greater convenience for maintenance personnel and require less time in which to perform authentication. This is particularly attractive where maintenance personnel, as part of system maintenance, must perform one or more system resets, which require the technician to login successively.

To provide the technician with flexibility when prolonged maintenance operations are required, the timer may be reset after the timer is initiated and before it expires, at the request of the technician.

To maintain system security after maintenance operations are completed, the second password may be prematurely deactivated in response to a command from the technician.

The second password can be limited to a specific login. For example, in addition to the second password a third (temporary) password can be associated with a second login different from the selected login.

The assigned life may be set by the user subject to rules governing the maximum permissible life of a temporary password. This provides the technician with the option of selecting a life commensurate with the anticipated duration of use of the temporary password, thereby avoiding the need to generate a password disablement command upon completion of password use.

These and other embodiments and advantages will be apparent from the disclosure of the invention(s) contained herein.

The above-described embodiments and configurations are neither complete nor exhaustive. As will be appreciated, other embodiments of the invention are possible utilizing, alone or in combination, one or more of the features set forth above or described in detail below.

### BRIEF DESCRIPTION OF THE DRAWINGS

FIG. 1 is a block diagram of a telecommunication system according to a first embodiment of the present invention; and

FIGS. 2A and B are flowcharts showing an operation of the access agent according to an implementation of the first embodiment.

### DETAILED DESCRIPTION

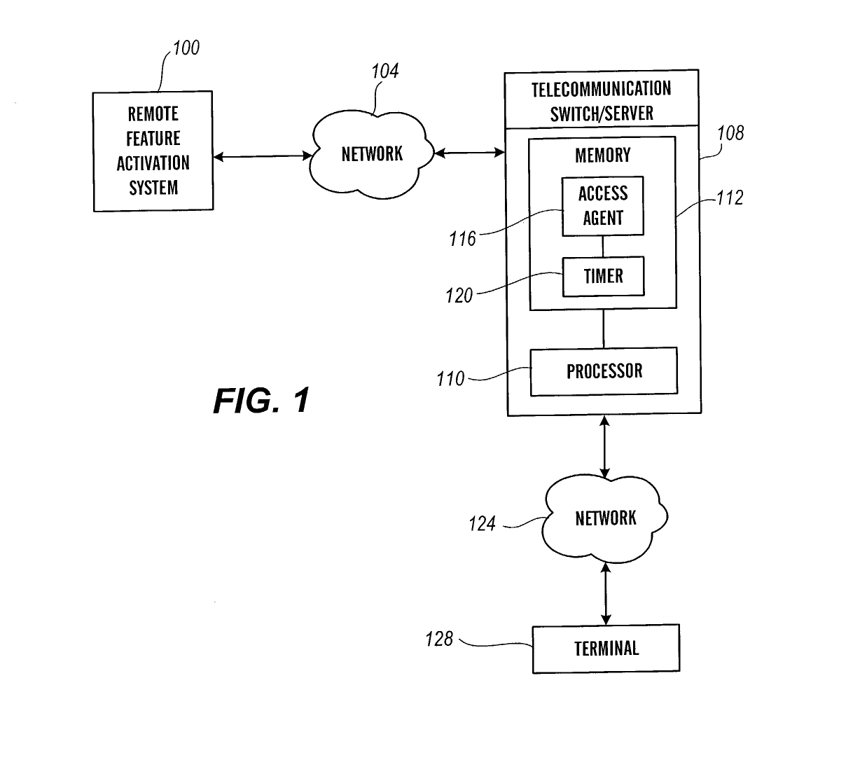

Referring to FIG. 1, a remote feature activation or RFA system 100 is used to generate and deliver static passwords and keys to service personnel, maintain an authentication database containing passwords and keys according to predetermined policies, and generate and deliver authentication files to switches and servers. The RFA system 100 delivers authentication files to target or requesting switches/servers, that typically run on an open operating system. Authentication files typically include not only passwords and/or keys (for dynamic password generation) but also related information (e.g., a unique platform identifier or PID, a unique system identifier or SID, a unique module identifier or MID, a functional location, and platform type associated with each stored password). Authentication file delivery generates the encrypted authentication file for delivery to the system over a geographically distributed processing network.

The data structures in the RFA database include, for each platform type and release (typically of the software loaded onto the switch/server), a serial swap-out indicator (that indicates whether or not a new authentication file is required when the license file serial number is changed in the remote feature activation system record), the location in password storage of the corresponding record (containing password(s)), a listing of logins or login names (an identifier associated with the user), whether a password is required (yes/no), any default passwords used before installation of an authentication file, the password length (for new password creation and existing password verification), availability of key protection (yes/no), and the key setting (on/oft). This database is used to determine what logins to use. The database also defines which logins require keys and which logins require passwords. The logins required for a switch/server are based on the platform (or switch/server) type or model and the software release.

The authentication file delivered to switches and servers typically include the platform type, serial number associated with the switch/server (typically the serial number of an associated processor in the switch/server), software release, right-to-use expiration date (for the loaded software), platform ID, a listing of login names and associated passwords, and a listing of login names and associated keys. The file typically contains password definitions for the logins requiring passwords and key definitions for the logins requiring keys.

Secure and unsecure users with basic (low level) logins can request authentication file delivery remotely from the RFA system 100. The file can be delivered by any medium, such as via a switch contact (via direct dial-in to the switch/server), email or Web download. The authentication files can include new or existing passwords or keys.

The RFA system 100, its database (not shown), and authentication files are further discussed in copending U.S. patent application Ser. No. 10/232,906, entitled “REMOTE FEATURE ACTIVATOR FEATURE EXTRACTION” to Walker et al.; Ser. No. 10/231,999, filed Aug. 30, 2002, and entitled “FLEXIBLE LICENSE FILE FEATURE CONTROLS” to Walker et al.; Ser. No. 10/232,507, filed Aug. 30, 2002, and entitled “LICENSE FILE SERIAL NUMBER TRACKING” to Serkowski et al.; Ser. No. 10/231,957, filed Aug. 30, 2002, and entitled “LICENSING DUPLICATED SYSTEMS” to Serkowski et al.; and Ser. No. 10/232,647, filed Aug. 30, 2002, and entitled “SOFTWARE LICENSING FOR SPARE PROCESSORS” to Walker et al.; Ser. No. 10/232,508, filed Aug. 30, 2002, and entitled “LICENSE MODES IN CALL PROCESSING”, to Rhodes et al.; and Ser. No. 10/348,107, filed Jan. 20, 2003, and entitled “REMOTE FEATURE ACTIVATION AUTHENTICATION FILE SYSTEM” to Walker et al., each of which is incorporated herein by reference.

A telecommunication switch/server 108 is in communication with the RFA system 100 by means of network 104 (which can be a digital or analog network that uses any protocol, including TCP/IP, Ethernet, ISDN, and the like). The telecommunication switch/server 108 can be any suitable system, such as the MULTIVANTAGE™, S8700™, S8300™, and S8100™ switches/servers sold by Avaya, Inc. The switch/server 108 comprises memory 112 and a processor 110. The switch/server comprises an access agent 116 and timer 120 for performing user authentication to provide security for switch/server 108. The access agent 116, for example, performs authentication using temporary static and dynamic passwords and generates and delivers temporary static passwords to service personnel. A terminal 128, such as a PC, is connected via network 124 to the switch/server to permit users to interface with the switch/server. The terminal preferably includes a graphical user interface for the user.

The access agent 116, as a precondition for providing a temporary static password, authenticates a user using a dynamic password. The login associated with the user is then password protected (for a specific port of the switch/server 108) using the temporary password. The timer 120 is initiated when the password is initiated. As will be appreciated, the timer 120 can be a countdown or countup timer. The duration of the timer (or life of the temporary password) can be of any selected length, with a typical shift length (e.g., 8 hours) being preferred. When the timer expires, the temporary static password can no longer be used unless reissued by the agent 116 after successful dynamic password authentication. The switch/server maintains the timer value in non-volatile memory along with the temporary password so that the timer 120 is preserved through system resets.

When the temporary password is active, login via dynamic passwords (and, in some configurations, other non-temporary static passwords) are still enabled so that, if a user forgets/loses the temporary password, he or she can still gain access to the switch/server 108 using a dynamic password. The temporary password can be renewed before the timer expires, if desired, by re-issuing the command for a temporary password. A command is also provided to disable the temporary password if the technician completes the work before the timer expires and does not want to leave the switch/server vulnerable to unauthorized access.

By using service logins requiring dynamic passwords, this approach provides strong security against would-be intruders. Once access is gained via dynamic passwords, the temporary password can be activated and then used by the user to quickly login as needed for the desired service activity (when the user is a technician or other type of service personnel). The login returns to dynamic password protection when the timer expires or the user disables the temporary password. The timer 120 ensures that, even if the user does not disable the temporary password login, the switch/server will return the login to dynamic password protection.

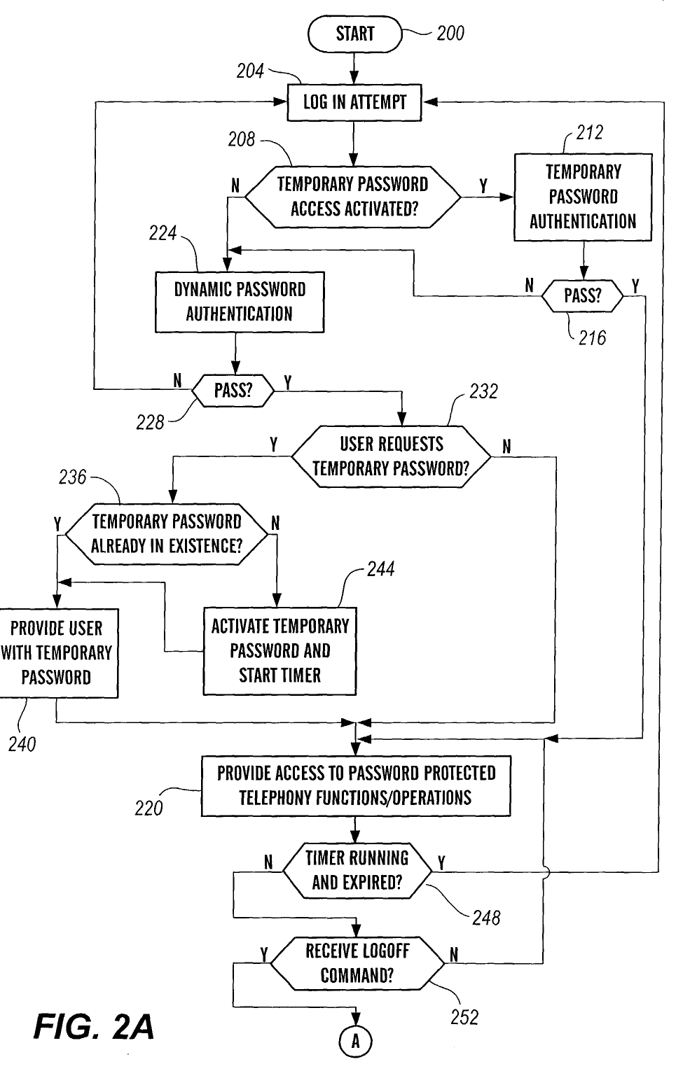

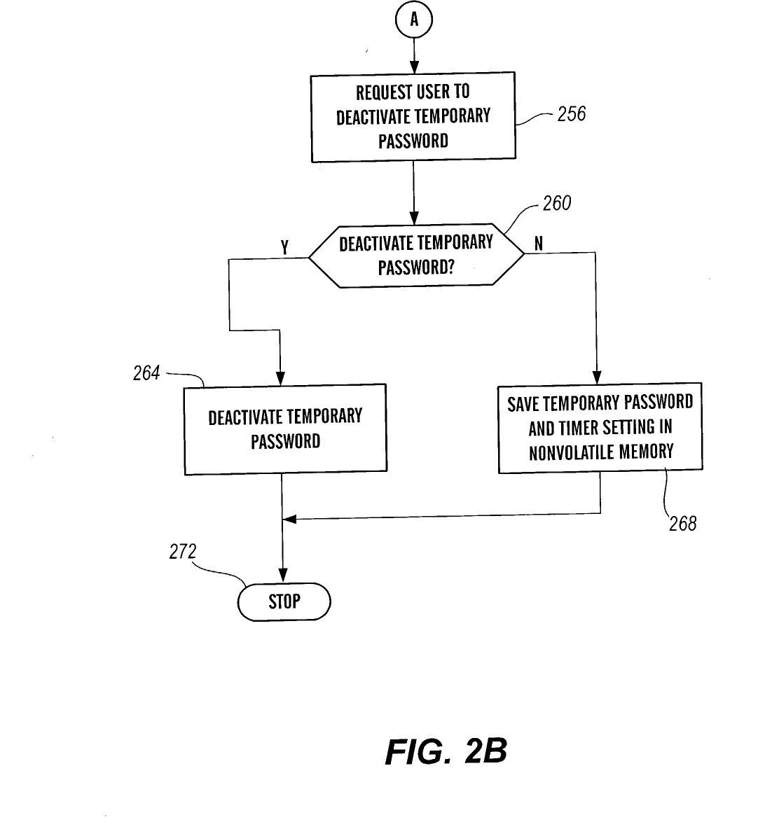

The operation of the access agent 116 timer 120 will now be discussed with reference to FIGS. 2A and B assuming that the user is a service technician.

Referring to FIG. 2A, the service technician in step 200 initiates a login sequence, such as by turning on or resetting terminal 128 or switch/server 108, and in step 204 receives a login display and attempts a login by, for example, inputting into the login display a sequence of symbols, whether alphabetical, numerical, or a combination thereof.

The access agent 116 in decision diamond 208 determines whether or not temporary password access has been activated. Temporary password access is activated when at least one active temporary password is in existence (e.g., the timer has not expired and no disable command has been received). When a temporary password is in existence, the agent 116 in step 212 performs temporary password authentication. This is typically performed by retrieving the active temporary password(s) recorded in nonvolatile memory and comparing the active temporary password(s) with the sequence of symbols inputted by the technician. In decision diamond 216, an exact match is considered a “pass” and a non-match a “fail”. When a pass is found to exist, the agent 116 proceeds to step 220 (discussed below). When a fail is found to exist, the agent 116 proceeds to step 224.

In step 224, dynamic password authentication is effected by the agent 116. As will be appreciated, a dynamic password is generated using a secret key (stored in the authentication file) and typically includes both letters and numbers, though it can include only letters or numbers. In dynamic passwords, to gain access to a protected login the technician must enter a correct response to a challenge presented by the agent. The correct response to the challenge is calculated by the service technician based on knowledge of a secret key. Typically, the challenge is used along with the key to mathematically generate the correct response. The agent 116 finds a “pass” when it receives the correct response and a “fail” when it receives an incorrect response. When a “pass” is found, the agent proceeds to decision diamond 232, and, when a “fail” is found, the agent returns to step 204 and reinitiates the login sequence.

In decision diamond 232 if the user does not request a temporary password, the access agent proceeds to step 220 (discussed below). When the technician requests to receive a temporary password, the access agent 116 proceeds to another decision diamond, namely decision diamond 236, to determine whether or not an active (unexpired) temporary password is already in existence. If so, the access agent 116 in step 240 retrieves the temporary password from the nonvolatile memory of the switch/server 108 and provides the temporary password to the user along with the remaining life of the temporary password. The user may request the life of the temporary password to be reset to its original value when the temporary password was originally issued. If not, the access agent 116 in step 244 activates a temporary password using a predetermined random or pseudo-random algorithm or fixed set of predetermined temporary passwords and initiates the timer 120 to determine when the life of the temporary password is expired. The temporary password and password life are provided to the user in step 240.

After completing step 240 or if the answer to the questions in either of decision diamonds 216 or 232 is negative, the access agent 116 proceeds to step 220. In step 220, the user is provided with access to password-protected telephony functions and operations to perform system maintenance and service. If the user resets the system and logs back onto the system, the temporary password may be used to gain access to these functions and operations without the need for successful completion of the dynamic password challenge/response procedure.

Periodically during step 220, the access agent 116 performs decision diamond 248 in which the agent determines whether or not the timer 120 has been started and, if so, if the timer has expired. Although not shown, the access agent 116 can interrupt step 220 to notify the user when the remaining period on the timer has reached one or more predetermined levels. In this way, the user can request an extension of the password life or reset of the timer value. If the timer has expired, the user is denied further access to the system and the system automatically terminates the user's session. In that event, the access agent 116 returns to step 204. If the timer value has not expired, the access agent 116 proceeds to decision diamond 252.

In decision diamond 252, the agent 116 determines whether or not a logoff command has been received. If not, the access agent does not interrupt step 220. If so, the agent 116 in step 256 requests the user to deactivate the temporary password.

In decision diamond 260, the agent 116 determines whether or not the user has requested the agent 116 to deactivate the temporary password. If so, the agent 116 in step 264 deactivates the password. If not, the agent 116 in step 268 saves the temporary password and timer value in nonvolatile memory. In either case, the agent 116 terminates operation in step 272.

A number of variations and modifications of the invention can be used. It would be possible to provide for some features of the invention without providing others.

For example in one alternative embodiment, the various modules referenced herein are implemented as software, hardware (e.g., a logic circuit), or a combination thereof.

In another alternative embodiment, the division of the various functions performed by the various modules in the authentication file system are different.

In yet another alternative embodiment, the life of the temporary password is determined by the user with a predetermined maximum life being stipulated by the system. Thus, when a temporary password is requested the user can request a duration of the timer 120 that is less than or equal to the predetermined maximum timer duration.

In yet a further alternative embodiment, to provide support for automated software tools the dynamic password challenge rather than a temporary password request is presented for all logins, which, rather than entering the response to the challenge, can request the option to enter a temporary password. By clicking on the temporary password option on the dynamic password challenge screen, the agent would then present the user with a further display requesting entry of the temporary password. In this manner, tools will not be rendered nonoperational by the use of a temporary password.

In yet another alternative embodiment, the challenge request is presented to a login rather than a temporary password request, and the user inputs either the correct response to the challenge or a temporary password. The agent 116 will determine first whether the inputted sequence of symbols is the correct challenge response or dynamic password and, if not, second whether the inputted symbol sequence is the correct temporary password (if the temporary password is active or unexpired).

In yet another further embodiment, the option to activate and use a temporary password is limited to a subset of logins rather than made available to each of multiple logins.

In yet another alternative embodiment, where multiple logins exist a temporary password can be linked to each login. Thus, at one time more than one temporary password can be active. For a given login to use a temporary password, the correct temporary password for that login must be entered. Entering a temporary password for another login will not gain access to the system.

In yet another alternative embodiment, temporary passwords maybe activated before an authentication file is installed on the switch/server 108.

In yet another alternative embodiment, an active temporary password login is unaffected by the installation of a new authentication file.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g. for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover though the description of the invention has included description of one or more embodiments and certain variations and modifications, other variations and modifications are within the scope of the invention, e.g. as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for providing access to a computational component, comprising:
(a) authenticating a user using a first password;
(b) after the user is successfully authenticated using the first password, receiving a request from the user for a second password to be authorized for at least one of the user and a login associated with the user;
(c) providing the user with the second password; and
(d) initiating a timer to determine when an assigned life for the second password has expired.

2. The method of claim 1, further comprising:
(e) when the assigned life for the second password has expired, deactivating the second password.

3. The method of claim 1, wherein the first password is a dynamic password and the second password is a nondynamic password.

4. The method of claim 1, wherein a first life of the first password is greater than the assigned life of the second password.

5. The method of claim 1, further comprising:
(e) after the timer is initiated, receiving a request to reset the timer to a selected value; and
(f) resetting the timer to the selected value.

6. The method of claim 1, further comprising:
(e) after receiving a command to deactivate the second password, deactivating the second password.

7. The method of claim 1, wherein a third password having an assigned life is active and is associated with a second login different from the login associated with the user.

8. The method of claim 1, wherein the assigned life is selected by the user.

9. The method of claim 1, further comprising after the steps of claim 1:
(e) authenticating the at least one of the user and the login using the second password rather than the first password.

10. The method of claim 1, further comprising after the steps of claim 1:
(e) authenticating the user, wherein a sequence of characters is received from the user and wherein during authenticating step (e):
comparing the sequence of characters with a third password, the third password being different from the first password;
when the sequence of characters is different from a third password, comparing the sequence of characters with the second password; and
when the sequence of characters is identical to the third password or the second password, the user is successfully authenticated.

11. A telecommunications component, comprising:
a timer; and
an access agent operable to (a) authenticate a user using a first password; (b) after the user is successfully authenticated using the first password, receive a request from the user for a second password to be authorized for at least one of the user and a login associated with the user; (c) provide the user with the second password; and (d) initiate the timer to determine when an assigned life for the second password has expired.

12. The component of claim 11, wherein the access agent, when the assigned life for the second password has expired, is operable to deactivate the second password.

13. The component of claim 11, wherein the first password is a dynamic password and the second password is a static password.

14. The component of claim 11, wherein a first life of the first password is greater than the assigned life of the second password.

15. The component of claim 11, wherein the access agent, after the timer is initiated, is operable to reset the timer to a selected value in response to a request from the user.

16. The component of claim 11, wherein the access agent is operable to deactivate the second password in response to a request from the user.

17. The component of claim 11, wherein a third password having an assigned life is active and is associated with a second login different from the login associated with the user.

18. The component of claim 11, wherein the assigned life is selected by the user.

19. The component of claim 11, wherein the agent, after performing the steps of claim 1, is operable to authenticate the at least one of the user and the login using the second password rather than the first password.

20. The component of claim 11, wherein the agent, after performing the steps of claim 1, is operable to (e) authenticate the user, wherein a sequence of characters is received from the user, wherein during authentication operation (e) the agent (i) compares the sequence of characters with a third password, the third password being different from the first password; (ii) when the sequence of characters is different from a third password, compares the sequence of characters with the second password; and (iii) when the sequence of characters is identical to the third password or the second password, successfully authenticates the user.

21. A method for authenticating a user, comprising:
(a) receiving a sequence of characters from a user;
(b) comparing the sequence of characters with a first password, the first password being a dynamic password; and
(c) when the sequence of characters is different from the first password, comparing the sequence of characters with a second password, the second password being a nondynamic password and having a predetermined life.

22. The method of claim 21, wherein the user is authenticated successfully either (i) when the sequence of characters in comparing step (b) is identical to the first password or (ii) when the sequence of characters in comparing step (c) is identical to the second password.

23. A method for authenticating a user, comprising:
(a) receiving a sequence of characters from a user;
(b) comparing the sequence of characters with a first password, the first password being a dynamic password; and
(c) comparing the sequence of characters with a second password, the second password being a static password and having a predetermined life, wherein step (b) is performed when the sequence of characters is different from the second password.

24. The method of claim 21, wherein the user is authenticated successfully either (i) when the sequence of characters in comparing step (b) is identical to the first password or (ii) when the sequence of characters in comparing step (c) is identical to the second password.
